(19) United States
(12) Patent Application Publication
(10) Pub. No.: US 2011/0176388 A1
(43) Pub. Date: Jul. 21, 2011

(54) SWITCHING POWER SUPPLY

(75) Inventors: Tony Brock-Fisher, Andover, MA (US); Michael C. Bradshaw II, Waltham, MA (US)

(73) Assignee: KONINKLIJKE PHILIPS ELECTRONICS N.V., Eindhoven (NL)

(21) Appl. No.: 13/119,647

(22) PCT Filed: Oct. 7, 2009
(86) PCT No.: PCT/IB2009/054397

§ 371 Date: Mar. 17, 2011

Related U.S. Application Data
(60) Provisional application No. 61/104,899, filed on Oct. 13, 2008.

(51) Int. Cl. G01S 15/02; H04R 31/00

(52) U.S. Cl. 367/87; 29/594

(57) ABSTRACT

The patent application describes a switching power supply, wherein the supply has a first output voltage, wherein the first output voltage was generated by a first working voltage with a first frequency and a first phase, wherein the supply is adapted to configure the first frequency and/or the first phase in such a way that disturbances m devices powered by the supply are reduced, wherein the disturbances are caused of electromagnetic interferences. In an embodiment the switching power supply is adapted to configure the first frequency in such a way that the first frequency and its harmonies are different from the operating frequency of the powered device.

### FIELD OF THE INVENTION

The present invention relates to a switching power supply. Particularly, the present invention relates to a method for manufacturing the supply according to the invention. Further, the invention relates to an ultrasound system which comprises a switching power supply according to the invention. Furthermore, the invention is related to a method for manufacturing the ultrasound system according to the invention. Particularly, the present invention relates to a radio receiver which comprises a switching power supply according to the invention. Further, the present invention relates to a method for manufacturing the radio receiver according to the invention. Furthermore, the present invention is related to a device incorporating wireless communication which comprises a switching power supply according to the invention. Particularly, the present invention relates to a method for manufacturing the device according to the present invention.

### BACKGROUND OF THE INVENTION

The concept of switching power supplies has been known and practiced for a long time. The reduced size, weight, and increased efficiency makes switching power supplies the design architecture of choice when there is a need to convert voltage levels. Switching power supplies operate by switching a DC source into a reactive component (inductor or capacitor) to provide a voltage conversion. High efficiency is realized due to the use of saturated switching elements (typically high current FETs) and very fast switching times.

One well known disadvantage of switching supplies is that they are prone to causing large transients which can be coupled into their outputs, or radiated electromagnetically from the circuitry. This undesired energy, whether radiated or conducted from the switcher, occurs at the switching frequency and at integer harmonics of the switching frequency.

Due to the advances in microelectronics, it frequently becomes necessary to use multiple technology solutions in an application. This results in the requirement for multiple high-current supplies of differing voltages. A power supply implementing multiple switchers operating from a common input voltage is a convenient way to provide these differing voltages.

Many contemporary applications operate at RF and are susceptible to interference from switching power supplies. Specific examples include a Diagnostic Ultrasound System, and an HF Radio Receiver.

### SUMMARY OF THE INVENTION

Accordingly, there might be a need for a switching power supply, wherein the supply is adapted to reduce disturbances in devices powered by the supply, wherein the disturbances are caused of electromagnetic interferences. Particularly, there might be a need for a method for manufacturing the supply, wherein the supply is adapted to reduce disturbances in devices powered by the supply, wherein the disturbances are caused of electromagnetic interferences. Particularly, there might be a need for an ultrasound system which comprises a switching power supply, wherein the supply is adapted to reduce disturbances in devices powered by the supply, wherein the disturbances are caused of electromagnetic interferences. Particularly, there might be a need for a method for manufacturing the ultrasound system, wherein the system comprises a supply, which is adapted to reduce disturbances in devices powered by the supply, wherein the disturbances are caused of electromagnetic interferences. Particularly, there might be a need for a radio receiver which comprises a switching power supply, wherein the supply is adapted to reduce disturbances in devices powered by the supply, wherein the disturbances are caused of electromagnetic interferences. Particularly, there might be a need for a method for manufacturing the radio receiver, wherein the radio receiver comprises a supply, wherein the supply is adapted to reduce disturbances in devices powered by the supply, wherein the disturbances are caused of electromagnetic interferences. Particularly, there might be a need for a device incorporating wireless communication, wherein the device comprises a supply, wherein the supply is adapted to reduce disturbances in devices powered by the supply, wherein the disturbances are caused of electromagnetic interferences. Particularly, there might be a need for a method for manufacturing the device, wherein the device comprises a supply, wherein the supply is adapted to reduce disturbances in devices powered by the supply, wherein the disturbances are caused of electromagnetic interferences.

These needs may be met by the subject matter according to one of the independent claims. Advantageous embodiments of the present invention are described in the dependent claims.

According to a first aspect of the present invention it is proposed a switching power supply, wherein the supply has a first output voltage, wherein the first output voltage was generated by a first working voltage with a first frequency and a first phase, wherein the supply is adapted to configure the first frequency and/or the first phase in such a way that disturbances in devices powered by the supply are reduced, wherein the disturbances are caused of electromagnetic interferences.

A gist of the present invention may be seen as based on the following idea:

Switching power supplies are operating with a determined frequency for chopping a DC-voltage. This chopping frequency and harmonics thereof result in disturbances. The disturbances can be of the type of wire-conducted. It is also possible that the disturbances, generated by the switching power supply, lead to electromagnetic radiation. The disturbances should be suppressed in order to guarantee the proper function of electronic devices, which are connected to the switching power supply or which are arranged in the neighbourhood of the switching power supply. According to the invention the chopping frequency will be controlled in such a way, that the disturbances and/or the harmonics thereof can be easily filtered. Another aspect of the invention is to change the chopping frequency in such a manner that the disturbances can not impact other electronic devices, e.g. because the frequencies of the device are total different to the chopping frequency and/or the harmonics thereof.

According to a second aspect of the invention it is proposed a method for manufacturing the supply according to one of the claims 1 to 5, comprising the step of adaption of the supply such that the first frequency and/or the first phase is configured in such a way that disturbances in devices powered by the supply are reduced, wherein the disturbances are caused of electromagnetic interferences.

According to a third aspect of the invention it is proposed an ultrasound system which comprises a switching power supply according to one of the claims 1 to 5, wherein the ultrasound system is adapted to reduce the disturbances by configuring the first frequency and/or the first phase of the supply.

According to a fourth aspect of the invention it is proposed a method for manufacturing the ultrasound system according to claim 7, comprising the step of adaption of the system such that the first frequency and/or the first phase is configured in such a way that disturbances in the system are reduced, wherein the disturbances are caused of electromagnetic interferences.

According to a fifth aspect of the invention it is proposed a radio receiver which comprises a switching power supply according to one of the claims 1 to 5, wherein the radio receiver is adapted to reduce the disturbances by configuring the first frequency and/or the first phase of the supply.

According to a sixth aspect of the invention it is proposed a method for manufacturing the radio receiver according to claim 9, comprising the step of adaption of the radio receiver such that the first frequency and/or the first phase is configured in such a way that disturbances in the radio receiver are reduced, wherein the disturbances are caused of electromagnetic interferences.

According to a seventh aspect of the invention it is proposed a device incorporating wireless communication which comprises a switching power supply according to one of the claims 1 to 5, wherein the device is adapted to reduce the disturbances by configuring the first frequency and/or the first phase of the supply.

According to a eighth aspect of the invention it is proposed a method for manufacturing the device according to claim 11, comprising the step of adaption of the device such that the first frequency and/or the first phase is configured in such a way that disturbances in the device are reduced, wherein the disturbances are caused of electromagnetic interferences.

According to an embodiment of the invention it is proposed a switching power supply, wherein the supply is adapted to supply an ultrasound device, wherein the ultrasound device has an operating Doppler frequency, wherein the supply is adapted to configure the first frequency in such a way that the first frequency and harmonics thereof are different to the operating Doppler frequency.

In the case of an ultrasound system, it may be advantageous to control the switching frequency in such a way that its frequency or phase characteristics are modified to minimize and mitigate the effects of interference from the switching power supplies. For example, synchronizing the switching frequency to the operating Doppler frequency acts to make the interference occur at an output of zero velocity, where it can be rejected easily by a clutter filter.

According to a further embodiment of the invention it is proposed a switching power supply, wherein the supply is adapted to supply an electronic device, wherein the electronic device has an operating frequency, wherein the supply is adapted to configure the first frequency in such a way that the first frequency and harmonics thereof are different to the operating frequency.

According to an exemplary embodiment of the invention it is proposed a switching power supply, wherein the supply has a first output voltage, wherein the first output voltage was generated by a first working voltage with a first phase, a second output voltage, wherein the second output voltage was generated by a second working voltage with a second phase, wherein the supply is adapted to control the first phase with respect to the second phase in such a way that the disturbances are reduced.

Often, RF sensitive devices are designed to operate at multiple RF frequencies. Ultrasound systems use different frequencies for different clinical applications. Radio receivers are typically tunable for many reasons. Therefore there is a need for a multiple switching power supply architecture that can be configured to reduce output interference in a specific and dynamic band of interest.

Specifically, if the phases of the switchers are not controlled in a simple, fixed, evenly distributed manner as described above, it is possible to control the band of frequencies of greatest cancellation of the undesired energy. This invention attempts to capture the concept of a multiple output switching power supply operating at multiple switching phases, where the switching phases are dynamically controllable in any way that acts to reduce output interference in a desired band of frequencies.

For example, in a simple case of four supplies, a maximum reduction in interference can be controlled to occur at the second harmonic of the switching frequency by selecting two of the switchers to operate at 0 phase, and the other two to operate at 180 degrees. This will result in a higher level of interference at twice the switching frequency, and even integer harmonics. This would be appropriate if the RF sensitive device needed to operate at an odd harmonic frequency of the switching frequency. If the RF device also, at another time, needs to operate at a third harmonic of the switching frequency, the switcher could be reconfigured to operate at 90 degrees phase difference between individual switchers. This will result in reduction of interference at frequencies that are not at multiples of four times the fundamental switching frequency.

According to an alternative embodiment of the invention it is proposed a switching power supply, wherein the supply is adapted in such a way that the second working voltage is switched on after or in the moment the first working voltage is switched off.

For the case of multiple switchers all operating at the same frequency, in this case all switchers are operating in phase, whereby the energy from each switcher can add coherently, resulting in large impulse interference. This can significantly degrade a 2D ultrasound image.

A mitigating approach to this problem is to control the phase of the multiple switchers such that the noise does not add up to large impulses. Specifically, if there are N switchers, the Mth switcher can be controlled to start its switching event at a relative phase of (M/N)*360 degrees. This will act to spread out the energy of the switching event over the total switching period, and thereby reduce the peak impulse energy of the switcher's noise.

However, a problem exists with this approach: The interference from a switcher occurs at integer harmonics of the switching frequency. If the switching frequency is lower than the frequency of operation, harmonics of the switching frequency can still fall within the band of frequencies of operation.

If the phases used to control the switching event of N switchers are simply evenly distributed as in the example above, this will serve to cause cancellation and enhancement of the harmonic components at various frequencies. For example, in the simple case of two switchers operating 180 degrees out of phase, the energy at the fundamental switching frequency will cancel. However, given a fundamental sine component described by:

V=A sin(w*t+phi)
where
   w=angular frequency
   t=time
   phi=phase
      the Nth harmonic will be described by:

Vn=A sin(n*w*t+n*phi).

Specifically, as the phase of the fundamental is adjusted by phi, the phase of the Nth harmonic will be adjusted by N times phi.

The result of this is that the energy in the harmonics of a multiple output switching supply where N switchers are phased in an equally spaced amount across one switching period will be enhanced at a frequency corresponding to the Nth harmonic of the switching frequency.

This Nth harmonic may fall within the passband of interest of the RF sensitive device, such as an ultrasound system.

### BRIEF DESCRIPTION OF THE DRAWINGS

The aspects and embodiments defined above and further details of the present invention may be apparent from an exemplary embodiment to be described hereinafter with reference to the figure but to which the invention is not limited.

FIG. 1 shows a switching power supply with one DC output,

FIG. 2 shows a switching power supply with two different DC outputs.

### DETAILED DESCRIPTION OF THE INVENTION

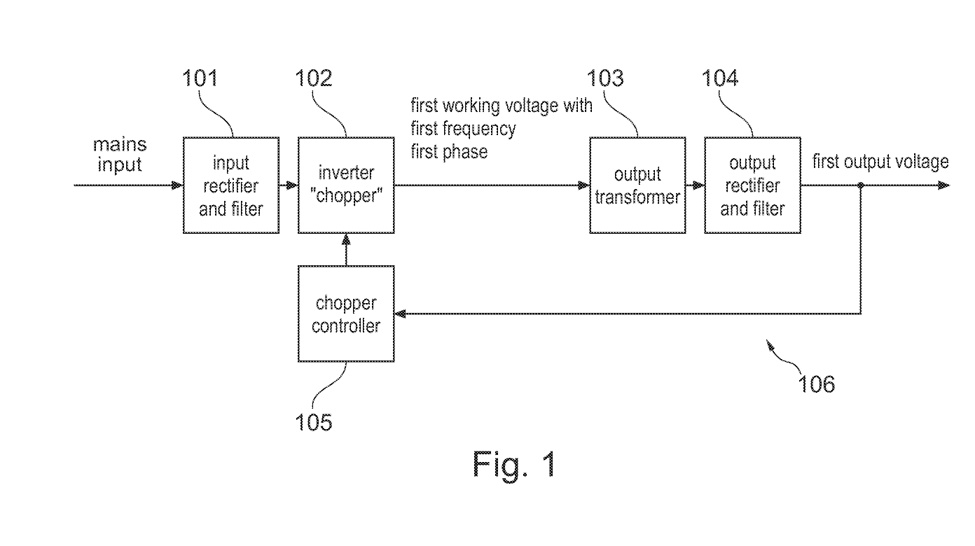

FIG. 1 shows a block diagram of a switching power supply 106. It is depicted the input, wherein in this case it is a mains input. It is also possible that the input of the switching power supply could be supplied by another AC-voltage or a DC-voltage. In case that the input is supplied by a DC-voltage it is not necessary to rectify the input voltage. Therefore, in this case the input rectifier 101 can be omitted. In case the input is supplied by an AC-voltage the input voltage will be rectified by the input rectifier 101. Usually a filter will be combined with the input rectifier 101 in order to suppress disturbances coming from the mains supply. The resulting rectified DC voltage will be chopped by the inverter 102. This inverter 102 will be controlled by the chopper controller 105, wherein the chopper controller 105 controls the inverter 102 with a first frequency and a first phase. Due to the chopping with the first frequency and the first phase a first working voltage will be generated, which has the first frequency and the first phase. This first working voltage will be fed to the output transformer 103, wherein the output transformer 103 is important because of the electrical isolation. The secondary voltage of the output transformer will be rectified by the output rectifier 104. Usually, the output rectifier 104 comprises also a filter for suppressing disturbances because of the chopping of the first working voltage. The resulting first output voltage will be watched by the chopper controller 105 in order to provide a closed loop controlling of the first output voltage. The chopper controller 105 controls the first frequency and the first phase. The frequency of the disturbances are determined by the first frequency. According to the invention the chopper controller 105 varies the first frequency and the first phase in order to minimize the disturbances, which can e.g. be measured at the output of the switching power supply.

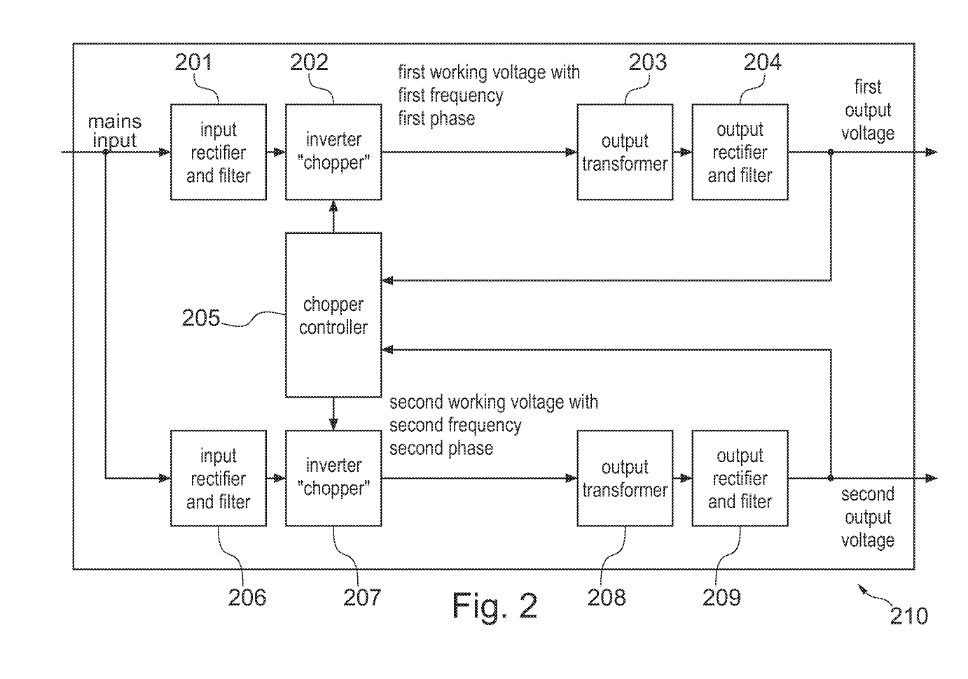

FIG. 2 shows a block diagram of a switching power supply, wherein the switching power supply comprises two switching power supplies of the type depicted in FIG. 1. It is depicted the input, wherein there could be a mains supply as well as a DC voltage. In case there is a DC voltage there is no need for the input rectifiers 201, 206. There are inverters 202 and 207, output transformers 203, 208 and output rectifiers 204, 209. The output voltage of the inverter 202 is the first working voltage with a first frequency and a first phase. The output voltage of the inverter 207 is the second working voltage with a second frequency and a second phase. The output voltage of the output rectifier 204 is the first output voltage. The output voltage of the output rectifier 209 is the second output voltage. The first output voltage and the second output voltage will be measured by the chopper controller 205. Instead of having two chopper controllers there is only one. This single chopper controller 205 is adapted to control the first and/or the second frequency and/or the first and/or the second phase in such a manner that the disturbances are minimized, which can be measured e.g. at the first output voltage and/or e.g. at the second output voltage.

The above descriptions incorporate the simplifying assumption that all switchers cause equal interference components. This is almost never the case, especially if there are positive as well as negative voltage outputs. However, even given unmatched outputs, it is possible to find a switching phase configuration that will result in a reduced level of interference in a specific band of interest.

It should be noted that the term ‘comprising’ does not exclude other elements or steps and the ‘a’ or ‘an’ does not exclude a plurality. Also elements described in association with the different embodiments may be combined.

It should be noted that the reference signs in the claims shall not be construed as limiting the scope of the claims.

### LIST OF REFERENCE SIGNS

101 input rectifier and filter,
102 inverter
103 output transformer,
104 output rectifier and filter,
105 chopper controller,
201 input rectifier and filter,
202 inverter
203 output transformer,
204 output rectifier and filter,
205 chopper controller,
206 input rectifier and filter,
207 inverter
208 output transformer,
209 output rectifier and filter,
210 chopper controller.

1. An ultrasound system which comprises a switching power supply, wherein the supply has a first output voltage, wherein the first output voltage was generated by a first working voltage with a first frequency and a first phase, wherein the supply is adapted to configure the first frequency and/or the first phase in such a way that disturbances in devices powered by the supply are reduced, wherein the disturbances are caused of electromagnetic interferences; and
an ultrasound device which operates at an operating Doppler frequency,
wherein the supply is adapted to configure the first frequency in such a way that the first frequency and harmonics thereof are different from the operating Doppler frequency.

2.-3. (canceled)

4. The ultrasound system according to claim 1, wherein the supply has
a first output voltage, wherein the first output voltage was generated by a first working voltage with a first phase,
a second output voltage, wherein the second output voltage was generated by a second working voltage with a second phase, wherein the supply is adapted to control the first phase with respect to the second phase in such a way that the disturbances are reduced.

5. The ultrasound system according to claim 4, wherein the supply is adapted in such a way that the second working voltage is switched on after or in the moment the first working voltage is switched off.

6. A method for manufacturing the ultrasound system according to claim 1, comprising the step of adaption of the supply such that the first frequency and/or the first phase is configured in such a way that disturbances in devices of the system powered by the supply are reduced, wherein the disturbances are caused of electromagnetic interferences.

7.-12. (canceled)
